(19) United States
(12) Patent Application Publication
(10) Pub. No.: US 2002/0113782 A1
(43) Pub. Date: Aug. 22, 2002

(54) Display system for processing a video signal

(76) Inventors: Henricus Renatus Martinus Verberne, Eindhoven (NL); Willem Gerard Ophey, Eindhoven (NL)

Correspondence Address: Corporate Patent Counsel, U.S. Philips Corporation, 580 White Plains Road, Tarrytown, NY, 10591, US

(21) Appl. No.: 10/078,935

(22) Filed: Feb. 19, 2002

(30) Foreign Application Priority Data
Feb. 21, 2001 (EP) 01200624.3

(51) Int. Cl. G09G 5/00

(52) U.S. Cl. 345/204

(57) ABSTRACT

The invention relates to a display system comprising an electronically operated display and an electronic processing and computing means, arranged to output a display signal at a predetermined refresh rate for displaying images in a predefined resolution. The display system is configured to receive a video signal from a video source. The processing and computing means transforms the video signal into a display signal. According to the invention, the display system is set to display an image in a format having a high-resolution part and a low-resolution part, such that a portion of the low-resolution part circumscribes at least a portion of the high-resolution part. The processing and computing means is adapted to operate in accordance with at least one of a set of measures including the skipping of computations for defining intermediate pixels of the display area with the low-resolution part, defining the display pixels of the low-resolution part to be larger than the display pixels of the high-resolution part, and reducing the intensity of the signal in the low-resolution part in order to reduce the power consumption of the display system.

The present invention relates to a display system as defined in the preamble of claim 1.

Such systems are generally known. They may be applied, for instance, in a portable computer system or laptop, generally provided with a liquid crystal display (LCD). With the continuous growth of consumer demand for quality and versatility of such systems, the known display technologies are pushed to their limits when video signals based on moving pictures are required to be transformed to display signals, which, in principle, are primarily adapted to represent still pictures, such as in information-representing displays. This is, for instance, the case in computer displays.

In the video world, most video sources use an interlaced display format according to which the video signal is provided. This implies that each image frame of the signal is scanned in the form of two fields which are temporarily separated and, upon display, are specially offset in the vertical direction. Generally, composite video signals have a refresh rate of 60 Hz in an interlaced format and a resolution of 720×242 pixels per display field, whereas PAL colour composite video signals have a refresh rate of 50 Hz interlaced and a slightly high resolution of pixels per field, each standardised signal having a pixel clock rate in the range of 13.5 MHz to 14.75 MHz. However, liquid crystal displays and other information displays, which are required to become larger and larger in present-day applications, must have resolutions of 1280×1024 pixels per display or more. In addition, these displays are driven in a non-interlaced mode and have refresh rates up to 75 Hz or even higher.

Incorporation of typical video images on a typical information display such as an LCD thus requires several video signal processing steps so as to obtain a display signal. One step is an interlaced to non-interlaced conversion to obtain a progressive scan format of the display signal. A conversion step is required in the form of scaling to accommodate to the different display resolution, whereas also a scan rate conversion step is required to accommodate the video signal refresh rate to that of the display refresh rate. All steps are performed by the electronic processing and computing means which are thereby pushed to the limit, and it will be evident that all the video processing steps may be at the expense of video image quality and processing power or implementation costs. There are various advanced algorithms for controlling the electronic processing and computing means, which boost performance at the expense of processing power. The electronics are put to the limit by the circumstance that the amount of signal processing required in video applications is approximately linear to the display refresh frequency and the increase of pixels per field resolution.

It is an object of the present invention to provide a display system which does not have the drawback of a relatively enormous power consumption by at least overcoming the trade-off problems associated therewith. According to the invention, this is realised by the features of the characterizing part of claim 1.

Surprisingly, the present solution is achieved by taking advantage of the circumstance that, particularly in larger displays, only part of the display area focuses the attention of the user of common computer applications, which may typically be the active window of a set of windows through which the user of such systems interacts with the system. In this application, the active window is a part of the image which is displayed with the required resolution, while the other windows are displayed in the low-resolution part of the image. In general, the high-resolution part of an image is relevant to the user of the system. The invention as defined also provides a set of measures for favourably applying the idea underlying the invention in a display system to which the invention relates.

The idea underlying the invention starts from a perceptive point of view, knowing that the human eye is more susceptible to off-axis flicker. To solve the problem in this area, the invention is based on the recognition that flicker perception increases with brighter images. Thus, obtaining a higher quality field of view in display applications is at the expense of perception of flicker, which is known to be reducible by increasing the display refresh frequency, whereas an increase of the display resolution is required for preserving the percepted resolution.

According to a further embodiment of the present invention, use is made of knowledge in the biological field in which the human eye may cover a full field of view of over 100°, but in which the resolved resolution degrades significantly beyond a field of view ranging up to 15° from the fovea centralis which is the centre of the eyes' visual field. Already at 10° from the fovea centralis, the visual acuity drops to 20 to 25% of that in the fovea centralis area.

Thus, the invention further relates to a display system which comprises eye-tracking means for defining the user's fovea centralis and for interacting with the processing and computing means, such that the relatively high-resolution part is set in correspondence with the instantaneous fovea field as reflected on the display during use.

Surprisingly, the power demand of a display system according to the invention is significantly reduced by the application of such measures. It is further recognized in the present invention that the power and processing demand of such an eye-tracking device is much lower and almost negligible in comparison with the processing efforts which are required when transforming a video signal in real time.

The invention will now be elucidated in accordance with a drawing in which

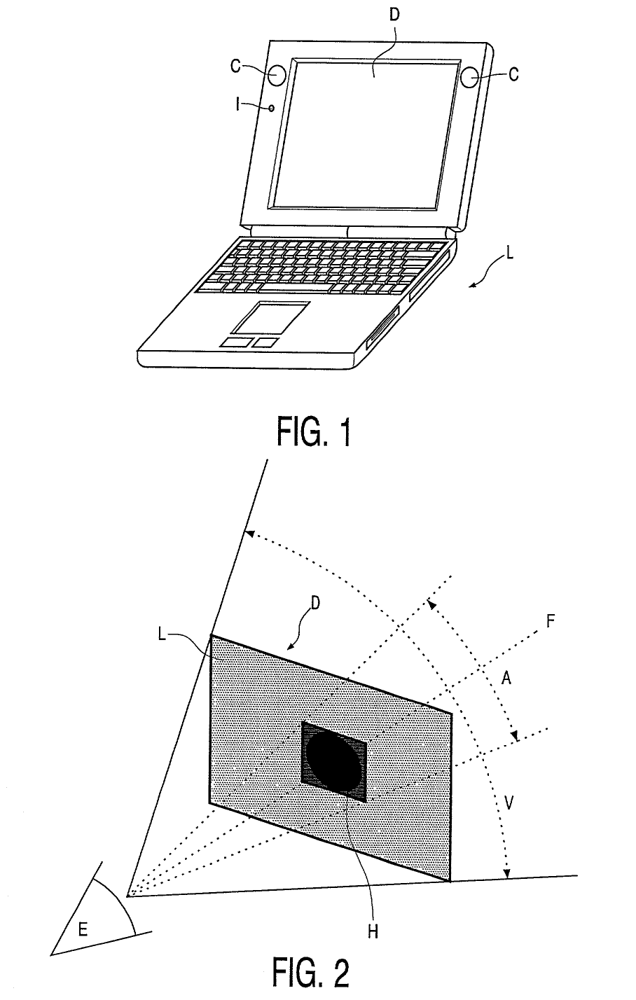

FIG. 1 schematically represents a typical application of the present invention, whereas

FIG. 2 illustrates the application, according to the invention, of features of the human eye.

In FIG. 1, a laptop computer P, provided with a liquid crystal display D in a hingable cover portion of the laptop, is equipped with eye-tracking means, comprising a pair of cameras C and an infrared light-emitting source I, the light of which is invisible to the human eye. The eye tracking means I, C connect to control means S incorporated in the laptop computer P, and schematically indicated by broken lines. The laptop computer P further comprises electronic processing and computing means μP, likewise schematically indicated by broken lines, and arranged for outputting a display signal to the display D at a particular refresh rate and for displaying images with a predefined resolution. Those skilled in the art will appreciate that the control means S and the processing an computing means μP operate under the control of suitable processing software stored in the laptop computer P. The infrared emitter I is generally directed to the generally expected position of the user while cameras C and the pertaining control means are directed to tracking the eyes by distinguishing, in a manner known per se, the infrared reflections from the eyes' pupils and the circumscribing area of the eye. For controlling the eye-tracking means, a relatively simple processing unit is applied which, as a result of its processing actions, outputs a signal to the central processing and computing means defining the instantaneous position of the fovea relative to the cameras.

As may be seen in FIG. 2, the human eyes E in the present example perceive a field of view V of a display area D, relative to a central focused line F passing through the centre of the fovea area A and a centre point between the eyes E of the user. The fovea area A ranges in a cone-like area of up to 15° from the centre line F. On the display D, this fovea area A could be mirrored as a circular section H, which, for ease of application in the system, defines a rectangular area to be displayed with the high resolution which is resolvable by the eye, whereas, according to the invention, the area outside such a frame is displayed in a lower resolution L.

In the present application, the view area V defined by the dimensions of the display D and the manner in which it is used typically ranges around 60°.

While the output video bandwidth or the required processing power is usually the bottleneck in high-resolution LCD applications for visual perception, it is known that the eye is capable of resolving the full display resolution only in the fovea area. This means that most of the video bandwidth and the processing power is wasted by providing full resolution of the display region outside this area.

By measuring the position of the user's eyes in relation to the display by means of the eye tracker, a tool is provided for the processing algorithm to track the position on the display which reflects the fovea area A. This enables the algorithm to only process full-resolution data located in this area and has the benefits that the output video bandwidth and processing power may be decreased significantly because the fovea area A is only a small part of the total display size, especially in the high end field of view applications. The resolution in the non-fovea area is also reduced for instance, by skipping the calculations for intermediate pixels, thus decreasing the need for processing power. While this creates a less bright image, the result in turn is a decrease of flicker perception according to the invention, and the optimal scenario would be to reduce the display refresh frequency, thus again decreasing the output bandwidth and processing power needs. In this respect, alternative, but simultaneously applicable measures according to the invention include a measure of increasing the size of the display pixels making up the image in the non-fovea area L relative to the pixel size in the fovea area A, while the intensity of the display signal in the non-fovea area L may also be reduced relative to the intensity of the signal in the fovea area A. The systems according to the invention are directed to and intended for a single display. However, a second display or even more displays may be incorporated in the system, while the characterizing features are still directed to and intended for each display of the system.

The arrangement according to the invention and its benefits results in the ability to apply, for example, a more demanding algorithm for improved image quality, to allocate more silicon for peripheral hardware tasks or to reduce costs because the demand for processing power decreases significantly.

Apart from the above description and all details of the drawing, the invention further relates to the features defined in the attendant claims.

1. A display system comprising an electronically operated display and an electronic processing and computing means, arranged to output a display signal to the display provided with pixels composing an image on the display, characterized in that the system is adapted to display the image in a format having a relatively high-resolution part and a relatively low-resolution part, the processing and computing means being adapted to operate in accordance with at least one of a set of measures including the skipping of computations for defining intermediate pixels of the display area with the relatively low-resolution part, defining the display pixels of the low-resolution part to be relatively large as compared to the display pixels of the high-resolution part, and reducing the intensity of the signal in said relatively low-resolution part.

2. A display system as claimed in claim 1, in which the relatively high-resolution part (H) is an image part which is instantaneously relevant to the user of the system.

3. A display system as claimed in claim 1 or 2, in which the system comprises eye-tracking means for defining the user's fovea and for interacting with the processing and computing means, such that the relatively high-resolution part (H) is set in correspondence with the instantaneous fovea.

4. A display system as claimed in any one of the preceding claims, in which the measure for the relatively low-resolution area (L) is applied at an intensity decreasing with the distance from the centre of the fovea.

5. A display system as claimed in any one of the preceding claims, in which at least a portion of the relatively low-resolution part circumscribes at least a portion of the relatively high-resolution part.

6. A computer system comprising a display system as claimed in any one of the preceding claims.
